(19) United States
(12) Patent Application Publication
(10) Pub. No.: US 2007/0163172 A1
(43) Pub. Date: Jul. 19, 2007

(54) Biodegradable mat containing superabsorbent polymers

(76) Inventor: Milan H. Savich, Beaverton, OR (US)

Correspondence Address: STOEL RIVES LLP - SLC, 201 SOUTH MAIN STREET, ONE UTAH CENTER, SALT LAKE CITY, UT, 84111, US

(21) Appl. No.: 11/333,619

(22) Filed: Jan. 17, 2006

(51) Int. Cl. A01C 1/04

(52) U.S. Cl. 47/56

(57) ABSTRACT

A delivery mechanism for delivering superabsorbent polymer (“SAP”) products is disclosed. The delivery mechanism comprises a horticulture mat that may include two cellulose substrate sheets bonded together with SAP particles disposed between the sheets. The horticulture mat may optionally include seed, fertilizers, herbicides, pesticides, fungicides and/or other growth-promoting additives.

### TECHNICAL FIELD

The present disclosure relates to superabsorbent polymer products and to methods and apparatuses for applying and delivering superabsorbent polymer products in horticultural and agricultural applications.

### BRIEF DESCRIPTION OF THE DRAWINGS

The embodiments disclosed will become more fully apparent from the following description and appended claims, taken in conjunction with the accompanying drawings. Understanding that these drawings depict only typical embodiments and are, therefore, not to be considered limiting of the scope of the appended claims, the embodiments will be described with additional specificity and detail through use of the accompanying drawings in which:

FIG. 1 is a partially cut-away perspective view of one embodiment of a horticulture mat containing superabsorbent polymer products;

FIG. 2 is a partially cut-away side cross-sectional view of one embodiment of a horticulture mat containing superabsorbent polymer products; and

FIG. 3 is a perspective view of one embodiment of a horticulture mat being unrolled for application.

### DETAILED DESCRIPTION

Those skilled in the art will recognize that the methods, components and compositions disclosed herein may be arranged and practiced in a wide variety of different configurations, such as without one or more of the specific details described, or with other methods, components, materials, etc. In some cases, well-known materials, components or method steps are not shown or described in detail. Furthermore, the described components, method steps, compositions, etc., may be combined in any suitable manner in one or more embodiments.

Thus, the following more detailed description of various embodiments, as represented in the Figures, is not intended to limit the scope of the present disclosure, but is merely representative of certain exemplary embodiments. While the various aspects of the embodiments are presented in drawings, the drawings are not necessarily drawn to scale unless specifically indicated.

Superabsorbent polymers (“SAPs”) are materials that imbibe or absorb at least 10 times their own weight in aqueous fluid and that retain the imbibed or absorbed aqueous fluid under moderate pressure. The imbibed or absorbed aqueous fluid is taken into the molecular structure of the SAP rather then being contained in pores from which the fluid could be eliminated by squeezing. Some SAPs can absorb up to, or more than, 1,000 times their weight in aqueous fluid.

SAPs may be used in agricultural or horticultural applications. The terms “agricultural” and “horticultural” are used synonymously and interchangeably throughout the present disclosure. Applying SAPs to soil in an agricultural settings have resulted in earlier seed germination and/or blooming, decreased irrigation requirements, increased propagation, increased crop growth and production, decreased soil crusting, increased yield and decreased time of emergence.

Synthetic SAPs are commercially available and are conventionally used in conjunction with baby or adult diapers, catamenials, hospital bed pads, cable coating and the like. However synthetic SAPs may also be used in agricultural applications. Another type of SAP product used more widely in agricultural applications include starch graft copolymers. Starch graft copolymers comprise a monomer graft polymerized onto a polysaccharide, such as a starch or cellulose. Starch graft copolymers are typically used to absorb aqueous fluids for use in absorbent softgoods, in increasing the water holding capacity of soils, and as coatings onto seeds, fibers, clays, and the like.

One method of producing a starch graft copolymer SAP for use in agricultural applications involves graft polymerizing acrylonitrile onto a starch in the presence of an initiator, such as a ceric (+4) salt, to form the starch graft copolymer, and saponifying the nitrile groups with an alkali metal to form a saponificate having alkali carboxylate and carboxamide groups.

Another method comprises (1) graft polymerizing a monomer, other than acrylonitrile, onto a starch in the presence of an initiator to form a starch graft copolymer; (2) cross-linking the starch graft copolymer, for example, by adding a cross-linking agent to cross-link the starch graft copolymer; (3) adjusting the pH of the cross-linked starch graft copolymer, e.g., neutralization; (4) isolating the cross-linked starch graft copolymer; and (5) drying the cross-linked starch graft copolymer.

Exemplary polysaccharides include cellulose, starches, flours, and meals. Exemplary starches include native starches (e.g., corn starch (Pure Food Powder, manufactured by A. E. Staley), waxy maize starch (Waxy 7350, manufactured by A. E. Staley), wheat starch (Midsol 50, manufactured by Midwest Grain Products), potato starch (Avebe, manufactured by A. E. Staley)), dextrin starches (e.g., Stadex 9, manufactured by A. E. Staley), dextran starches (e.g., Grade 2P, manufactured by Pharmachem Corp.), corn meal, peeled yucca root, unpeeled yucca root, oat flour, banana flour, and tapioca flour. The starch may be gelatinized to provide optimal absorbency. An exemplary starch is gelatinized cornstarch. Furthermore, according to one embodiment, the weight ratio of the starch to the monomer is in the range of between about 1:1 and about 1:6.

Exemplary initiators for graft polymerizing a monomer onto a starch include cerium (+4) salts, such as ceric ammonium nitrate; ammonium persulfate; sodium persulfate; potassium persulfate; ferrous peroxide; ferrous ammonium sulfate-hydrogen peroxide; L-ascorbic acid; and potassium permanganate-ascorbic acid. Other suitable initiators known to those skilled in the art may be used, such as alternative persulfates and peroxides, as well as vanadium, manganese, etc. The amount of initiator used may vary based on the chosen initiator, the selected monomer, and the chosen starch. Some initiators, e.g., persulfates, may require the presence of heat. The initiator may be added in a single or multiple steps, and multiple initiators may be used.

Exemplary cross-linking agents include: glycerides; diepoxides; diglycidyls; cyclohexadiamide; methylene bis-acrylamide; bis-hydroxyalkylamides, such as bis-hydroxypropyl adipamide; formaldehydes, such as urea-formaldehyde and melamine-formaldehyde resins; isocyanates including di- or tri-isocyanates; epoxy resins, typically in the presence of a base catalyst; and derivatives and mixtures thereof

According to the first exemplary method where acrylonitrile is graft polymerized onto a starch, the resulting starch graft copolymer may be saponified with an alkali metal, such as potassium hydroxide or sodium hydroxide, to convert the nitrile groups into a mixture of carboxamides and alkali carboxylates. The starch graft copolymer may then be precipitated.

In one embodiment, precipitation occurs via an acid titration. Acid, such as hydrochloric acid, nitric acid, sulfuric acid, or phosphoric acid may be added until a pH of between about 2.0 and about 3.5, more particularly about 3.0, is reached. The resulting precipitate may be washed with water to remove the salts, and if necessary, separated in some manner. Separating methods include settling, centrifuging, and other mechanical means of separating.

The carboxylic acid of the starch graft copolymer may then be titrated back to the alkali form with the hydroxide of an alkali metal, such as potassium hydroxide, to a pH of between about 6.0 and about 8.0, more particularly about 7.0. This viscous mass may then forced through a die plate, dusted to remove tackiness, and air or oven dried. The dried particles are then screened to the appropriate size. If desired, the particles could be ground to fine particles then formed into pellets of the desired size for use in agriculture.

In another embodiment, the isolated product is recovered from the viscous saponificate with the use of water miscible solvents such as alcohols. These include, for example, methanol, ethanol, propanol and isopropanol. The resulting dough is immersed into the alcohol, and the alkali starch graft copolymer is precipitated into particles that are optionally screened after drying to the desired size.

Formation of the starch-containing graft copolymers into particles of the desired size for direct use in agricultural equipment may be achieved by converting the viscous mass of alkali starch-graft copolymers into, for example, rod-shaped forms and drying the forms to the desired particle size. Selecting an appropriate die can vary the rod-shaped forms. A plate may be used that has been drilled or formed to contain holes of a particular size and shape. For example, the diameter of the rods may be controlled by the diameter of the holes drilled in the end plate. In one embodiment, the holes in the end plate may range from between about 1/16 inch to about ¼ inch in diameter. Rod-shaped forms may be lightly coated, after the die, to reduce their tackiness. Clays, starches, flours and cellulose may be used to dust the rods. In another embodiment, the starch graft copolymer may be isolated through the use of an extruder, such as through a heated screw.

According to another method of producing a SAP product, alternative monomers other than acrylonitrile are graft polymerized onto a starch in the presence of an initiator to form a starch graft copolymer. Exemplary alternative monomers include acrylic acid or methacrylic acid. Exemplary monomers may also include acrylamide or methacrylamide. Sulfonic acids, such as 2-acrylamido-2- methyl-propanesulfonic acid (AMPS) and vinyl sulfonic acid may also be used. Moreover, acrylates, such as ethyl acrylate and potassium acrylate may also be used. Derivatives and mixtures of the above-listed monomers may also be desirable.

In applications using acrylic acid, the addition of acrylamide thereto helps induce graft polymerization and adds to absorbency of the SAP. By way of example, the ratio by weight of acrylic acid to acrylamide may be about 2:1. Alternatively, the ratio of acrylic acid to acrylamide may also range up to a ratio of 9:1 and beyond. Because acrylamide is considered a neurotoxin, it may be desirable to reduce the relative amount of acrylamide to acrylic acid, while using enough to help induce graft polymerization of acrylic acid.

In alternative applications, acrylic acid may graft polymerize onto a starch or other polysaccharide without the assistance of acrylamide. For example, acrylic acid may polymerize when placed under heat and/or pressure. Polymerization without the addition of acrylamide may be accomplished, for example, in a heated screw extruder, such as a single screw or a double screw.

As described above, the monomer is graft polymerized onto a polysaccharide in the presence of an initiator to form a starch graft copolymer. Exemplary starches and initiators have been described above. The starch graft copolymer may then be cross-linked, for example, by adding a chemical cross-linking agent to form a cross-linked starch graft copolymer. It may be desirable for the starch graft copolymer to be cross-linked if it dissolves in aqueous fluids previous to being cross-linked. Cross-linking is one method to permit the starch graft copolymer to absorb aqueous fluids without dissolving. However, the amount of cross-linking agent added is typically indirectly proportional to the absorbency of the resulting SAP product. Exemplary cross-linking agents have also been described above.

Alternative methods of cross-linking may also be employed. For example, a solid SAP product may be cross-linked through irradiation, such as through exposure to gamma or x-ray electromagnetic radiation, or to an electron beam and the like. Irradiation facilitates cross-linking of the starch graft copolymer by creating free radicals in the copolymer chain. In some applications, after irradiation an annealing or melting process may be used to re-form the cross-linked copolymer chains. Furthermore, it may be desirable to perform the irradiation process in an atmosphere relatively free of oxygen.

Although the addition of cross-linking agents may be desirable in the production of SAPs, self-cross-linking copolymers may also be used. In a self-cross-linking copolymer, either a single self-reactive functional group or multiple self-reactive functional groups or multiple co-reactive functional groups are incorporated into the mixture. One exemplary co-reactive functional group is a copolymer of acrylic acid and glycidyl methacrylate.

The pH of the cross-linked starch graft copolymer may be adjusted to a desired value for the particular agricultural application. For example, the cross-linked starch graft copolymer may be neutralized to convert the carboxyl groups to potassium salts. Alternative pH values may be desirable depending upon the type of soil and the type of crop the resulting SAPs will be applied to. The resulting pH for most agricultural applications typically will range from about 6.0 to about 8.0. The desired pH may be greater or less than this range depending on the requirements for the particular agricultural application.

Alternatively, in some embodiments, pH adjustment of the starch graft copolymer may occur prior to cross-linking. Exemplary solvents that may be used to effect pH adjustment include potassium hydroxide, potassium methoxide, or a mixture thereof, any of which may optionally be diluted in methanol or other solvents.

In alternative embodiments, pH adjustment may not be necessary. For instance, if potassium acrylate were used as the monomer in lieu of acrylic acid, the resulting product may already be within an acceptable pH range.

The resulting pH-adjusted, cross-linked starch graft copolymer may then be isolated. One exemplary method of isolation involves simply drying the cross-linked starch graft copolymer, such as, for example, on a heated drum or via air-drying. The dried SAP product may then be pelletized according to pelletization methods known to those having skill in the art. According to this embodiment, isolation of the SAP product may be achieved in an alcohol-free environment.

In another embodiment, the step of isolating the starch graft copolymer involves extruding the cross-linked starch graft copolymer such as through a heated screw to form granules of SAP product. To minimize re-agglomeration of the granules, the granules may be coated with a dusting agent that decreases their propensity to stick together. Exemplary dusting agents include cellulose, clay, starch, flour, and other natural or synthetic polymers that prevent the granules from sticking together. Alternatively, the granules may be lightly sprayed with methanol to prevent them from sticking together, and/or the extrusion can be performed under high pressure.

Yet another exemplary method of isolating the starch graft copolymer involves precipitating the pH-adjusted, cross-linked starch graft copolymer using water-miscible solvents such as alcohols, e.g., methanol, ethanol, propanol, and isopropanol. Immersing the cross-linked starch graft copolymer in alcohol may cause the alkali starch graft copolymer to precipitate into particles that are later screened to the desired size after drying. The alcohol removes the water and extraneous salts from the cross-linked starch graft copolymer.

Another exemplary implementation of this method of precipitation involves blending sufficient methanol into the pH-adjusted, cross-linked starch graft copolymer to achieve a smooth dispersion. The smooth dispersion may then be pumped into a precipitation tank, which may include a stirring system that can vigorously mix the methanol while pumping in the smooth cross-linked starch graft copolymer dispersion. Once mixed, the resulting methanol and cross-linked starch graft copolymer particles may be collected by decanting or washing with methanol or centrifuged and collected, then dried to a moisture level of between about 1 percent and about 20 percent.

Another implementation of the isolation step through precipitation with methanol involves wetting the surface of the cross-linked starch graft copolymer with a small amount of methanol and then chopping the cross-linked starch graft copolymer into larger “chunks” that will not re-adhere to one another. Once the surface of the starch graft copolymer has been wetted with methanol, the resulting material is slippery to the touch and is no longer sticky. This effect may be achieved by using a compositional ratio of between about one part and about two parts of methanol per one part of solid.

Once the methanol has been added, the cross-linked starch graft copolymer may be pumped through an in-line chopper to form chunks having a diameter of less than one inch or, alternatively, hand-chopped with scissors. In one embodiment, the resulting mixture is then fed into a tank or Waring blender that has between about 1.5 gallons and about 4.0 gallons of additional methanol per pound of cross-linked starch graft copolymer. In some embodiments, the cross-linked starch graft copolymer may be subject to a pulverizer, in the presence of methanol, such as an in-line mixer or disintegrator which breaks the mass into smaller pieces as desired for the particular application. The methanol in the larger tank may be agitated with a Cowles dissolver or other mixer capable of achieving high speeds.

Yet another implementation of the isolation step through precipitation with methanol involves pre-forming the particle size before the methanol precipitation step. The use of dies to form strands or rods having different shapes and diameters can improve the particle size formation process. This particular implementation offers enhanced control of the final particle size. The cross-linked starch graft copolymer (neutralized or unneutralized) may be forced through a die plate having holes of varying diameter (e.g., about 1/16 inch to more than ¼ inch) and varying shapes (e.g., round, star, ribbon, etc.).

Methods of forcing the cross-linked starch graft copolymer through the die plate include using a hand-operated plunger, screw-feeding, auguring, pumping, and any other commonly known method. The resulting strands or rods may be placed into the precipitation tank without any further addition of methanol as a premixing agent. The strands or rods may be treated to prevent them from sticking together by, for example, wetting or spraying the strands or rods with methanol or dusting them with a dusting agent, such as, for example, cellulose, clay, starch, flour, or other natural or synthetic polymers. The resulting strands or rods may be precipitated with agitated methanol, removed from the tank, and dried.

Alternatively, the cross-linked starch graft copolymer product may be mixed with a solvent, such as water, to form a slurry or gel.

Depending on the agricultural application, the final SAP product may have a particle size that is courser than about 300 mesh. For example, in some applications where the starch graft copolymer is applied directly into the soil with the crop, the particle size is courser than about 50 mesh, such as between about 8 to about 25 mesh. This particle size range correlates to commercially available granule applicators. Therefore, alternative particle sizes may be used.

Finer particle sizes are typically used in seed coating or root dipping applications. By way of example, the particle size for seed coating may be between about 75 and about 300 mesh, such as about 100 mesh. For root coating, the particle size may be between about 30 mesh and about 100 mesh, such as about 50 mesh.

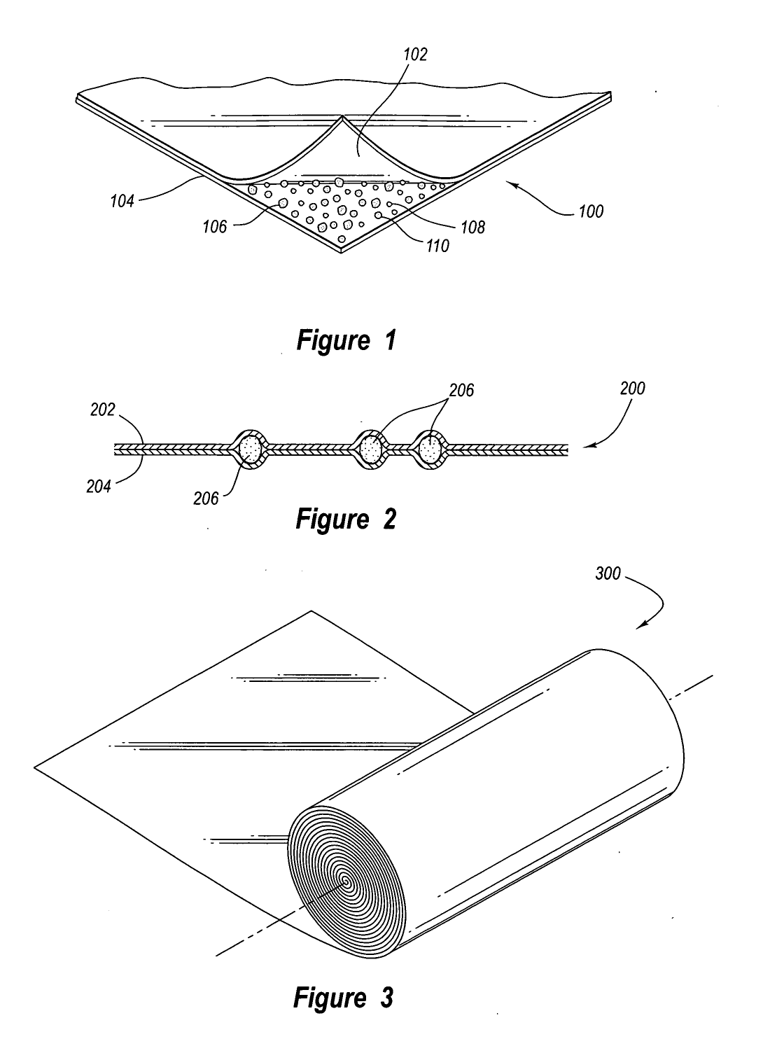

FIG. 1 represents one embodiment of a method of delivering a SAP in an agricultural setting comprising a biodegradable horticulture mat 100, as shown from a partially cut-away perspective view. The mat 100 may comprise a first sheet 102 that is bonded to a second sheet 104 through adhesives. Alternatively an aqueous based compression system may also be used. In one embodiment, the first and second sheets 102, 104 are biodegradable cellulose substrates. In an alternative embodiment, SAP particles may be introduced into peat pots, peat pellets, peat trays and compressed peat containers.

As shown in FIG. 1, cellulose sheets 102, 104 may be available from Buckeye Technologies, Inc., Georgia-Pacific Corp., or Koch Industries, Inc. However, alternative substrates may also be used such as synthetic or biodegradable nettings, peat papers, woven and other sheet materials.

SAP particles 106, such as the synthetic and starch graft copolymers disclosed herein, are disposed between the first and second cellulose sheets 102, 104. Additional media may also be introduced between the cellulose sheets 102, 104 along with the SAP particles 106. For example, seeds 108 and/or additional additives 110, such as fertilizers may also be disposed between the sheets 102, 104. Alternative or additional additives 110 that may be part of the horticulture mat 100 include pesticides, herbicides, fungicides, growth hormones and regulators, mycorrhizal fungi, kelp products, soil-based nutrients and the like.

The seed 108 that is optionally included in the horticulture mat 100 may be grass seed. Alternatively, crop seed may be included within the mat 100 such as commodity crops like corn or high-value crops such as tomato, celery and the like. Any suitable seed may be used as would be apparent to those having skill in the art. Furthermore, various fertilizers that are commercially available may be included as would be apparent to those having skill in the art. In some embodiments, controlled-release fertilizers may be included.

Exemplary pesticides that may be included in the horticulture mat 100 include, but are not limited to, acaricides, algicides, antifeedants, avicides, bactericides, bird repellents, chemosterilants, herbicide safeners, insect attractants, insect repellents, insecticides, mammal repellents, mating disruptors, molluscicides, nematicides, plant activators, plant-growth regulators, rodenticides, synergists, and virucides. Exemplary microbial pesticides include bacillus thuringiensis and mycorrhizal fungi. Exemplary insecticides include, but are not limited to, thiodan, diazinon, and malathion.

Exemplary commercially available pesticides include, but are not limited to: Admire™ (imidacloprid) manufactured by Bayer, Regent™ (fipronil) manufactured by BASF, Dursban™ (chlorpyrifos) manufactured by Dow, Cruiser™ (thiamethoxam) manufactured by Syngenta, Karate™ (lambda-cyhalothrin) manufactured by Syngenta, and Decis™ (deltamethrin) manufactured by Bayer. A combination or blend of pesticides may also be used. Alternative pesticides may also be used as would be apparent to those having skill in the art.

Fungicides may also be included in the matrix of the horticulture mat 100. Fungicides may help control or prevent the growth of mold or fungus on the seed or roots thus inhibiting root or seed rot. Exemplary commercially available fungicides include, but are not limited to: Amistar™ (azoxystrobin) manufactured by Syngenta, Folicur™ (tebuconazole) manufactured by Bayer, Opus™ (epoxiconazole) manufactured by BASF, Dithane™ (mancozeb) manufactured by Dow, Flint™ (trifloxystrobin) manufactured by Bayer, and Ridomil™ (metalaxyl) manufactured by Syngenta. A combination or blend of fungicides may also be used. Alternative fungicides may also be used as would be apparent to those having skill in the art.

Regarding pesticides and fungicides, starch-encapsulated pesticides or fungicides may imbibe water and swell such that the pesticide particles diffuse out of the starch matrix into the soil surrounding a plant, root, seed, or seedling in a controlled manner. Two goals of controlled-release pesticides or fungicides are (1) to increase efficacy of the pesticide/fungicide and (2) to reduce negative environmental consequences of pesticide/fungicide application.

Exemplary commercially available herbicides that may be included within the matrix of the horticulture mat 100 include, but are not limited to: Roundup™ (glyphosate) manufactured by Monsanto, Gramoxone™ (paraquat) manufactured by Syngenta, Harness™ (acetochlor) manufactured by Monsanto, Prowl™ (pendimethalin) manufactured by BASF, Dual™ (metolachlor) manufactured by Syngenta, and Puma™ (fenoxaprop) manufactured by Bayer. Furthermore, a combination or blend of herbicides may be used. Alternative herbicides may also be used as would be apparent to those having skill in the art.

Exemplary commercially available plant-growth regulators that may be optionally included in the matrix of the horticulture mat 100 include, but are not limited to: Ethrel™ (ethephon) manufactured by Bayer, Pix™ (mepiquat) manufactured by BASF, Dropp™ (thidiazuron) manufactured by Bayer, Finish™ (cyclanilide) manufactured by Bayer, and Royal MH™ (maleic hydrazide) manufactured by Crompton. A combination or blend of growth regulators may be used. Furthermore, growth inhibitors, growth retardants, growth stimulants, and derivatives and mixtures thereof may be included. Alternative growth regulators or hormones may also be used as would be apparent to those having skill in the art.

Exemplary soil-based nutrients that may be optionally included in the matrix of the horticulture mat 100 include calcium, magnesium, potassium, phosphorus, boron, zinc, manganese, copper, iron, sulfur, nitrogen, molybdenum, silicon, ammonium phosphate, fish meal, organic compounds and additives, organic based fertilizers derived from plant and animal products, and derivatives, blends, and mixtures thereof. More information about exemplary growth-promoting additives can be found in The Farm Chemicals Handbook published by Meister Publishing Company.

The SAP particles 106 within the horticulture mat 100 promote growth of the seeds 108 contained in the matrix or the seed or plant life adjacent to where the mat 100 is applied. Plant growth is facilitated by promoting the availability of beneficial nutrients to the plant, root, seed, or seedling. The high absorptivity of the SAP particles 106 facilitates entrapment of the fertilizers 110, growth-promoting additives and other additives heretofore described, thereby minimizing or eliminating disassociation or release of the additive 110 from the SAP matrix due to heavy rainfall, watering, etc. Because some amount of the additive 110 will become entrapped in the matrix of the SAP product 106, the runoff rate of additives 110 is significantly less than the runoff rate of additives applied directly to soil, plants, roots, seedlings, or seeds.

Additionally, the SAP particles 106 facilitate a more efficient uptake of nutrients and water to the plant, root, seed, or seedling. Increasing the availability of nutrients and/or water may affect an increase in crop yield, growth rate, seed germination, and/or plant size, and may affect earlier seed germination and/or blooming, decreased irrigation requirements, increased propagation, increased crop growth, increased crop production, decreased soil crusting, increased root development, stronger/heartier plants, and plants less susceptible to disease.

FIG. 2 represents an embodiment of a horticulture mat 200 containing SAP particles 206, as shown from a partially cut-away side cross-sectional view. As described above, the mat 200 comprises a first sheet 202 that is bonded to a second sheet 204, with the SAP particles 206 disposed there between. This particular embodiment of the horticulture mat 200 has a thickness of less than 2 millimeters. The thin and lightweight nature of the horticulture mat 200 allows a user to single-handedly carry an amount of the mat 200 that may be sufficient to cover a significant portion of a yard, such as when using the mat 200 to establish and promote germination of grass seed.

FIG. 3 represents one embodiment of a rolled horticulture mat 300 as shown from a perspective view. The horticulture mat 300 may be rolled for storage and transportation and subsequently unrolled for a particular agricultural application. According to one embodiment, the density of the horticulture mat 300 is such that an individual can single-handedly carry a roll of the mat 300 which may be applied across a significant area.

The horticulture mat 300 may be applied directly on or under soil to facilitate the growth of plant life (e.g., grass, crops, ground cover, etc.). The horticulture mat 300 may also be placed in a furrow to facilitate growth of seed planted therein, or alternatively to facilitate the growth of seed contained within the matrix of the horticulture mat 300. Furthermore, a section of the horticulture mat 300 may be placed or lined within a pot or hole before planting or transplanting a flower, shrub, etc.

Following application of the horticulture mat 300, a fluid may be applied at the location of the mat 300, such as water from sprinklers, rain, etc. or liquid fertilizer or other desirable chemicals and additives as would be apparent to those having skill in the art. The fluid is then imbibed or absorbed by the SAP particles contained within the mat 300.

While specific embodiments and applications have been illustrated and described, it is to be understood that the present disclosure is not limited to the precise configuration and components disclosed herein. Various modifications, changes, and variations which will be apparent to those skilled in the art may be made in the arrangement, operation, and details of the components, compositions and methods disclosed herein without departing from the spirit and scope of the following claims.

What is claimed is:

1. a horticulture mat, comprising:
a first biodegradable cellulose substrate disposed in sheet form;
a second biodegradable cellulose substrate disposed in sheet form and bonded to the first cellulose sheet, the first and second cellulose sheets forming a biodegradable mat; and
superabsorbent polymer particles disposed between the first and second cellulose sheets.

2. The horticulture mat of claim 1, wherein the superabsorbent polymer particles comprise acrylonitrile monomers.

3. The horticulture mat of claim 1, wherein the superabsorbent polymer particles comprise acrylic acid monomers.

4. The horticulture mat of claim 3, wherein the superabsorbent polymer particles further comprise acrylamide monomers.

5. The horticulture mat of claim 1, wherein the superabsorbent polymer particles comprises monomers that are at least one of the following: acrylic acid, acrylamide, methacrylamide, 2-acrylamido-2-methyl-propanesulfonic acid, methacrylic acid, vinyl sulfonic acid, ethyl acrylate, potassium acrylate, and derivatives and mixtures thereof.

6. The horticulture mat of claim 1, wherein the superabsorbent polymer is a starch graft copolymer.

7. The horticulture mat of claim 1, wherein the superabsorbent polymer is a synthetic polymer.

8. The horticulture mat of claim 1, further comprising seeds disposed between the first and second cellulose sheets.

9. The horticulture mat of claim 8, wherein the seed is grass seed.

10. The horticulture mat of claim 8, wherein the seed is crop seed.

11. The horticulture mat of claim 8, further comprising at least one of the following: fertilizers, herbicides, pesticides, fungicides, and growth regulators disposed between the first and second cellulose sheets.

12. The horticulture mat of claim 1, wherein the mat has a thickness that is less than two millimeters.

13. A horticulture mat, comprising:
a biodegradable substrate disposed in sheet form; and
superabsorbent polymer particles embedded in the biodegradable sheet;
wherein the superabsorbent polymer particles comprise monomers that are at least one of the following: acrylic acid, acrylamide, methacrylamide, 2-acrylamido-2- methyl-propanesulfonic acid, methacrylic acid, vinyl sulfonic acid, ethyl acrylate, potassium acrylate, and derivatives and mixtures thereof.

14. The horticulture mat of claim 13, wherein the superabsorbent polymer is a starch graft copolymer.

15. The horticulture mat of claim 14, wherein the starch graft copolymer is a cross-linked starch graft copolymer.

16. The horticulture mat of claim 13, wherein the biodegradable substrate comprises a cellulose-based substrate.

17. The horticulture mat of claim 13, wherein the biodegradable substrate comprises a first cellulose sheet bonded to a second cellulose sheet with the superabsorbent polymer particles disposed between the first and second sheets.

18. The horticulture mat of claim 13, wherein the monomer is a mixture of acrylic acid and acrylamide.

19. The horticulture mat of claim 13, further comprising seeds embedded in the biodegradable sheet.

20. The horticulture mat of claim 19, further comprising at least one of the following: fertilizers, herbicides, pesticides, fungicides, and growth regulators embedded in the biodegradable sheet.

21. A method of administering a superabsorbent polymer product in horticultural/agricultural applications, comprising:
obtaining a biodegradable cellulose mat comprising a first cellulose sheet bonded to a second cellulose sheet, having superabsorbent polymer particles disposed there between;
depositing the cellulose mat onto soil at a location where it is desirable to facilitate growth of plant life; and
applying a fluid to the location where the cellulose mat was deposited.
